(19) United States
(12) Patent Application Publication
(10) Pub. No.: US 2005/0056952 A1
(43) Pub. Date: Mar. 17, 2005

(54) Method of manufacturing multi-polymer optical fiber cable

(76) Inventor: James K. Walker, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/942,556

(22) Filed: Sep. 15, 2004

Related U.S. Application Data
(60) Provisional application No. 60/503,201, filed on Sep. 15, 2003.

(51) Int. Cl. B29D 11/00

(52) U.S. Cl. 264/1.29

(57) ABSTRACT

The subject invention pertains to a method and apparatus for manufacturing a plurality of polymer optical fibers. A polymer material is prepared and extruded to produce a plurality of polymer optical fibers in a continuous manner. One or more polymer optical fiber cables, each incorporating one or more of the plurality of polymer optical fibers, can be continuously produced from the plurality of polymer optical fibers. Examples of such polymer optical fiber cables include, but are not limited to, Simplex cable, Duplex cable, and other configurations of multi-polymer optical fiber cable. The polymer optical fiber can also be jacketed to produce a ribbon of polymer optical fibers and, optionally, two or more of the polymer optical fiber ribbons can be jacketed together to produce a stack of polymer optical fiber ribbons. The polymer optical fibers can have a variety of index refraction profiles, such as step index or GRIN (graded-index) profiles. These index profiles can be achieved by the combination of polmers used to produce the fibers, due to the different refractive indices of the polymers and/or by addition of one or more additives that modify the index of refraction of the polymers. Such additives can diffuse when heat and/or energy is provided to the polymer in order to achieve the desired index profile.

### CROSS-REFERENCE TO RELATED APPLICATIONS

The subject application claims benefit of U.S. provisional patent application Ser. No. 60/503,201, filed Sep. 15, 2003; this application also claims priority to U.S. Ser. No. 10/775,567, filed Feb. 10, 2004, which claims benefit of U.S. provisional application Ser. No. 60/446,369, filed Feb. 10, 2003; and U.S. Ser. No. 09/833,833, filed Apr. 12, 2001, which claims benefit of U.S. provisional application Ser. No. 60/196,687, filed Apr. 12, 2000.

### FIELD OF THE INVENTION

The present invention is generally related to a communication cable and, more particularly, is related to a method of high-speed, continuous manufacture of such cable.

### BACKGROUND OF THE INVENTION

Optical fiber cables have been used for many years to transmit information at high rates. The transmission media of the optical fiber cable may be from one to many hundreds of multimode glass fibers of 50 or 62.5 microns diameter. The fibers may be arranged singly, in groups, in ribbons, or in stacks of ribbons. Typical transmission distances are up to a few kilometers in length.

There are several relatively common cable structure families currently used to protect these thin optical fibers. Such cable structure families include the loose tube, the slotted core and the central core structures.

The glass optical fibers are delicate, very low ductility, and can be broken or cracked, either of which can destroy or degrade the signal transmitted. Therefore, the cable structure must be rugged to protect the fibers from mechanical damage. The quality of the signal transmitted through an optical fiber is also sensitive to tensile stress. Accordingly, tensile stiffness members must be included within the cable structure to carry the majority of tensile loads. These stiffness members may be both metallic and dielectric such as aramid and glass fibers embedded typically in a hard epoxy matrix.

The typical method of manufacture of fiber optic cables incorporating a plurality of fibers is described as follows:
(i) a glass preform is manufactured by any one of several techniques
(ii) the preform is lowered into a furnace in a tower and a fiber is drawn, clad, buffered and wound on to a spool in a manner well known in the art.
(iii) multiple spools, each containing fiber, are used to provide an array or ribbon of parallel coplanar fibers. Interstices between the fibers are filled with a UV or other type of curable matrix which is cured. The ribbon of fibers is wound on a spool.
(iv) multiple spools of ribbons of fibers may be arranged to form a stack of ribbons. Adjacent ribbons may be bonded to each other.
(v) optical fibers, bundles of fibers, ribbons and/or stacks of ribbons together with stiffness members are brought together and plastic jacketing materials are extruded over them in a high speed sheathing operation.

Many patents have been issued for the above processes involving cables incorporating glass optical fibers. They include U.S. Pat. No. 6,584,257 and U.S. Pat. No. 5,574,817 which describe ribbon fabrication and U.S. Pat. No. 4,900,126 which describes the manufacture of stacks of ribbons. Jacketing and choices of strengthening members are described in U.S. Pat. Nos. 6,594,427, 6,519,399 and U.S. Pat. No. 6,501,888.

Typically, in these manufacturing methods of optical fiber cables, the above processes take place in a series of distinct steps which occur sequentially, sometime with many hours of time delay between each step. Each step, as described, may be called a batch process. There is often no connection or feedback between the equipment used at each step in the process. As a result, such processes for manufacturing optical fiber cable generally require specialized labor at each step, inventory control of input and output materials at each step, and/or additional time for set-up of the materials and controls for each step of the process. There can also be material inefficiencies at the beginning or end of each batch process. Increased labor costs can be associated with the increase in overall production time of the multi-step process. Therefore, multi-fiber optical cable is currently therefore expensive to manufacture.

Thus, a heretofore unaddressed need exists in the industry to address the aforementioned inefficiencies and inadequacies of existing optical fiber cable manufacturing methods. Accordingly, there is a need for a cost-effective optical cable manufacturing process that is continuous and high speed from the initial step of starting from raw materials through to the production of multi-fiber optical cable.

### BRIEF SUMMARY OF THE INVENTION

The subject invention pertains to a method and apparatus for manufacturing an optical fiber cable incorporating a plurality of polymer optical fibers. In an embodiment, a plurality of optical fibers can be extruded simultaneously. In a specific embodiment, hundreds of polymer optical fibers can be simultaneously extruded. In further embodiments, some of these fibers may be combined on-line to produce ribbons. In yet further embodiments, some or all of the ribbons may be combined to produce stacks of ribbons. Fibers, bunches of fibers, ribbons, stacks of ribbons, and/or strengthening components may be gathered as in the existing manufacturing method and over-extruded to form an optical fiber cable in a continuous, high speed process.

There are many possible examples of the structure of the cable, the type of ribbon design, the type of ribbon stack design, the type of strengthening components and type of resin incorporated into the jacket. Further, the jacket polymer may incorporate various additives which confer advantages to the cable.

Other features and advantages of the present invention will become apparent to one with skill in the art upon examination of the following drawings and detailed description. It is intended that all such additional features and advantages be included herein within the scope of the present invention.

The invention can be better understood with reference to the following drawings. The components in the drawings are not necessarily to scale, emphasis instead being placed upon clearly illustrating the principles of the present invention.

### BRIEF DESCRIPTION OF THE DRAWINGS

FIG. 1 shows a schematic layout of a multifiber cable production facility in accordance with an embodiment of the subject invention.

FIG. 2A shows a schematic illustration of an apparatus for manufacturing optical fiber using two melts in accordance with the subject invention.

FIG. 2B shows a schematic illustration of a cross-section of a die which can be utilized in conjunction with the embodiment of the subject invention shown in FIG. 2A.

FIG. 3A shows a schematic illustration of an apparatus for manufacturing optical fiber using three melts in accordance with the subject invention.

FIG. 3B shows a schematic illustration of a cross-section of a die which can be utilized in conjunction with the embodiment of the subject invention shown in FIG. 3A.

FIG. 4A shows a cross-section of two GRIN POF's with each surrounded by an outer tubing and a jacket surrounding and holding together the fibers in accordance with the subject invention.

FIG. 4B shows a cross-section of two GRIN POF's with a jacket acting as an outer tubing and holding the fibers together in accordance with the subject invention.

FIG. 5 illustrates, in flow chart form, the steps for fabrication of plastic optical fiber in accordance with one embodiment of the invention.

FIG. 6 is a cross sectional view of a die, in accordance with an embodiment of the subject invention which is designed to provide four concentric layers of extruded polymeric material.

FIG. 7 is a schematic of an embodiment of the subject invention used to jacket the duplex fiber F1 and F2, where strengthening elements S1 and S2 are fed into the crosshead die, and the final product, duplex-jacketed POF is spooled.

FIG. 8 shows a schematic illustration of an apparatus for manufacturing a plastic optical fiber in accordance with the subject invention with extreme resistance to harsh environments.

FIG. 9 shows a schematic illustration of a cross-section of a die which can be used in conjunction with the apparatus shown in FIG. 2, in accordance with the subject invention.

The present invention will be described more fully hereinafter with reference to the accompanying drawings, in which preferred embodiments of the invention are shown. This invention may, however be embodied in many different forms and should not be construed as limited to the embodiments set forth herein; rather these embodiments are provided so that this disclosure will be thorough and complete, and will fully convey the scope of the invention to those skilled in the art.

### DETAILED DESCRIPTION OF THE INVENTION

The subject invention pertains to a method and apparatus for manufacturing a plurality of polymer optical fibers. A polymer material is prepared and extruded to produce a plurality of polymer optical fibers in a continuous manner. One or more polymer optical fiber cables, each incorporating one or more of the plurality of polymer optical fibers, can be continuously produced from the plurality of polymer optical fibers. Examples of such polymer optical fiber cables include, but are not limited to, Simplex cable, Duplex cable, and other configurations of multi-polymer optical fiber cable. The polymer optical fiber can also be jacketed to produce a ribbon of polymer optical fibers and, optionally, two or more of the polymer optical fiber ribbons can be jacketed together to produce a stack of polymer optical fiber ribbons.

The polymer optical fibers can have a variety of index refraction profiles, such as step index or GRIN (graded-index) profiles. These index profiles can be achieved by the combination of polmers used to produce the fibers, due to the different refractive indices of the polymers and/or by addition of one or more additives that modify the index of refraction of the polymers. Such additives can diffuse when heat and/or energy is provided to the polymer in order to achieve the desired index profile.

In an embodiment, the subject invention pertains to polymer optical fiber cable with at least one polymer optical fiber and at least one strength component. A cable jacket can be extruded to surround the polymer optical fiber and the strength component. The polymer optical fiber can be produced by polymer extrusion equipment.

U.S. patent application Ser. No. 09/833,833, filed Apr. 12, 2001 (U.S. Patent Publication No. 20020041042) teaches a method and apparatus for manufacturing a plastic optical transmission medium, and is incorporated herein by reference in its entirety. The Ser. No. 09/833,833 patent application teaches a method of producing polymeric optical fiber via an extrusion process and also teaches the simultaneous production of multiple optical fibers. U.S. Provisional Patent Application No. 60/446,369, filed Feb. 10,2003, and U.S. patent application Ser. No. 10/775,567 filed Feb. 10, 2004 teach a method and apparatus for manufacturing plastic optical transmission medium, and are incorporated herein by reference in its entirety. The 60/446,369 provisional patent application and Ser. No. 10/775,567 application teach a method of extrusion of perfluorinated and other polymeric material at high speed and also teach the simultaneous production of multiple optical fibers. In addition, U.S. Pat. Nos. 6,254,808 and 6,265,018 teach methods of extruding step-index and graded-index polymeric optical fibers, and are incorporated herein in their entirety.

The art of simultaneous extrusion of very large numbers of polymeric fibers has been highly developed by the textile industry in the last twenty years. In particular, a typical extrusion process of polyester microfibers involves the simultaneous production of a least two hundred fibers. It is possible to produce fibers with 50+/−1 micron diameter with each fiber being produced at a speed of at least 100 meters per minute. Typically, the micro fibers have a diameter less than 50 microns and have correspondingly higher production speeds. The high speed simultaneous production of large numbers of constant diameter micro-fibers is now well known in the art.

In an embodiment, the subject method can produce polymer optical fibers having diameters in the typical useful range for optical fiber diameters ranges from about 8 microns, corresponding to single mode fiber, up to about 50 to about 62.5 microns, corresponding to multimode fiber, and up to several hundred microns, corresponding to typical large diameter polymer optical fiber.

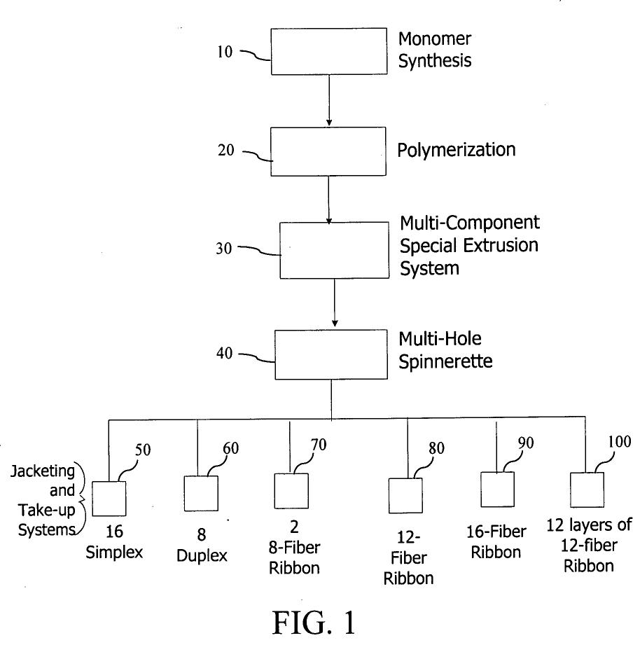

A schematic layout of a multifiber cable production apparatus in accordance with the subject invention is shown in FIG. 1. The fiber production can involve, as an example, the method described in the 60/446,369 patent application, which has been incorporated by reference. The method may include, for example, organic, partially fluorinated, fluorinated, fluoro plus chlorinated, halogenated carbon and silicon based polymers. In an embodiment, polymers can be selected with appropriate refractive index modifying additives, so as to produce fiber having high stability up to temperatures of at least about 85° C. In a further specific embodiment, polymers can be selected with appropriate refractive index modifying additives so as to produce fiber having high stability up to temperatures of at least about 125° C. High stability of the fiber at temperatures up to at least about 85° C. can be desirable for multifiber optical cable used in, for example, any outdoor application such as the internet access market. In the internet access market, as an example, a multifiber cable may be connected from an Ethernet Switch over a kilometer distance to hundreds of separate premises via hundreds of individual optical fibers within the cable. The method described in the 60/446,369 provisional patent application describes how to produce fiber having good optical transmission, for example <10 dB/kilometer. The 60/446,369 provisional patent application also describes how to produce fiber having a high bandwidth*distance product, for example 10 Gigabit per second over a distance of at least 300 meters or equivalently 3 Gigabit per second over a distance of one kilometer. High stability of the fiber at temperatures up to about 125° C. and high relative humidity can be useful when the fiber is used in the engine compartment of an automobile. The manufacture of such a fiber is described in U.S. provisional patent application entitled “Manufacturing Method of Acrylic optical Fiber with Improved Environmental Stability” and filed on Sep. 9, 2004 by the same inventor as the subject application, and is incorporated herein by reference in its entirety.

In the schematic layout shown in FIG. 1, several kg per hour of monomer is synthesized and purified continuously 10. Additives are added to effect polymerization 20 at appropriate temperature and pressure as described in the Ser. No. 09/833,833 and Ser. No. 09/446,369 patent applications. The polymer and additive materials are extruded 30 through a multi-hole spinneret 40 via, for example, micro-gear pumps. Refractive index modifying additives may be added to the material at different stages of the process.

Fibers that emerge from the multi-hole spinneret, can be drawn to provide a desired molecular alignment to meet specific mechanical specifications as is well known in the art. FIG. 1 shows a variety of examples of the ways in which the fibers emerging from the spinneret can be used to produce a desired fiber design. In a typical manufacturing facility a number (e.g., 16) of single fibers may be desired. They can be either spooled or jacketed on-line to provide a number of Simplex cables 50. In another embodiment, a number (e.g., 8) of Duplex cables may be produced on-line and jacketed to produce eight Duplex cables 60. Alternatively, pairs of fibers may be passed through a crosshead die and coated with ultra-violet curable polymer, cured, and spooled. Instead of all fiber pairs being jacketed on-line, none, one, two or more pairs of fibers may be spooled to be jacketed later as Duplex cable. A number (e.g., 2) of ribbons each containing 8 fibers may be produced 70. In the same way as described above, these ribbons may be produced on-line and jacketed. Alternatively, eight fibers may be passed through an eight-hole crosshead die, coated and cured. These ribbons may be used on line, as described below with respect to fiber stacks, or spooled for later use. The spooled ribbon may then be jacketed later to produce ribbon cable. Ribbons containing a larger number of fibers than 8 may be fabricated in the same way as described above 80, 90.

Ribbons of fibers produced as described, for example, with respect to 70, 80, and 90, may be used to produce stacks of ribbons 100. The fiber stacks may be jacketed to produce multifiber cable, in one case on-line and in the other, off-line. In further embodiments, multi-polymer optical fibers can be produced having a variety of configurations of multiple polymer optical fibers. These polymer optical fibers can be jacketed together to produce the cable in a specific embodiment.

In another embodiment of the invention, each single optical fiber may be passed through a crosshead die and clad with a polymeric layer of protective or buffer material. In a specific embodiment, 900 micron diameter polymeric layer can be used. Groups of these buffered fibers may be passed through a second crosshead die which produces a tube around the multiplicity of buffered fibers. A typical outside/inside diameter of such tubes is in the range of 5 mm/3 mm to 12 mm/10 mm. The number of buffered fibers within such tubes is typically in the range 8 to 50. These tubes containing buffered fibers may be spooled or used immediately in real-time. In the latter case, a number of the tubes are passed through a large crosshead die which permits the extrusion of an outer strengthened jacket which provides protection for the tubes each of which contains a multiplicity of buffered fibers.

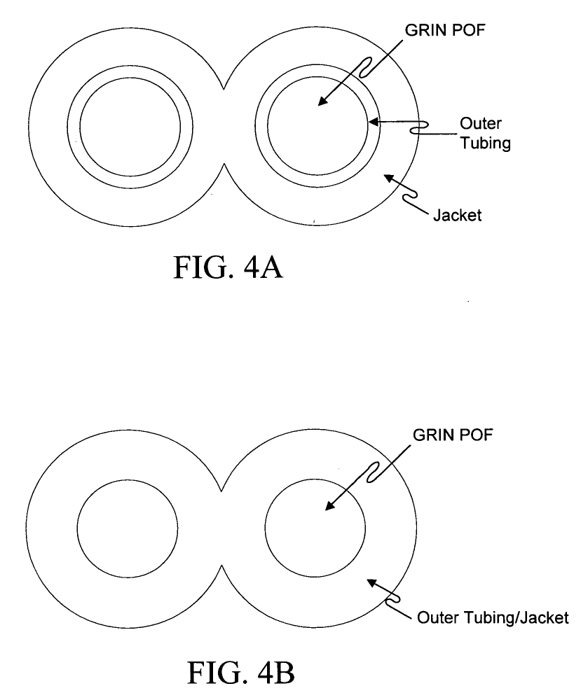

In the extrusion of the plurality of polymer optical fibers, each fiber can have an outer tube material and then a jacket material can be used to jacket one or more of the fibers together (see for example FIG. 4A) or the outer tube material can be positioned around the plurality of fibers (see for example FIG. 4B). The final Duplex, ribbon, or multi-polymer optical fiber cable can be designed, for example with indentations shown in FIG. 4A, such that one or more portions can be stripped away. For example, 8 Duplex cables can form a single 16 fiber cable where each end Duplex cable can be grabbed and stripped away from the remaining block of Duplex cables.

The following examples describe some of the methods and apparatus for producing polymer optical fibers in accordance with the subject invention. The examples often focus on an apparatus for the production of a single polymer optical fiber, but it is understood that the apparatus can be modified for simultaneous production of a plurality of polymer optical fibers in accordance with the subject invention by, for example, replicating the structure of the described apparatus. The materials presented are not intended to be limiting, but, rather, are intended to provide specific examples of materials that can be utilized in accordance with the subject invention.

### EXAMPLE 1

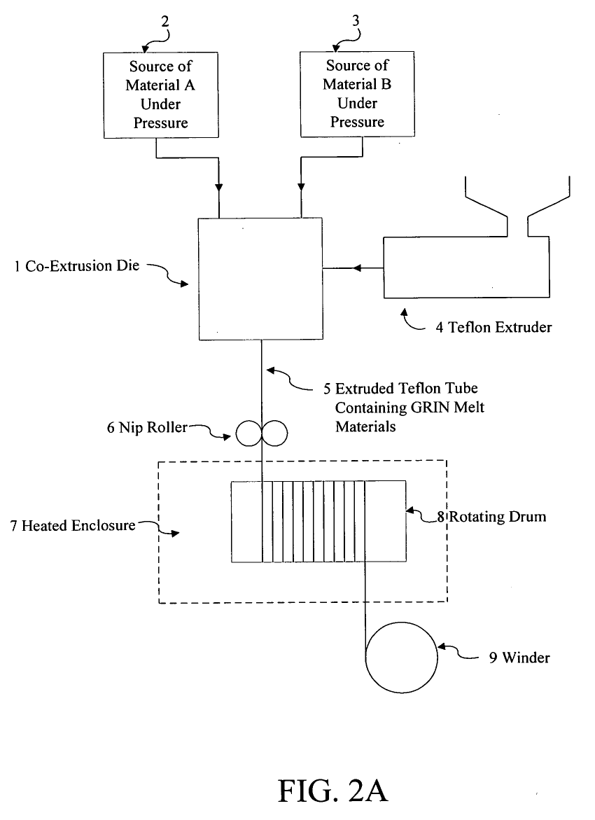

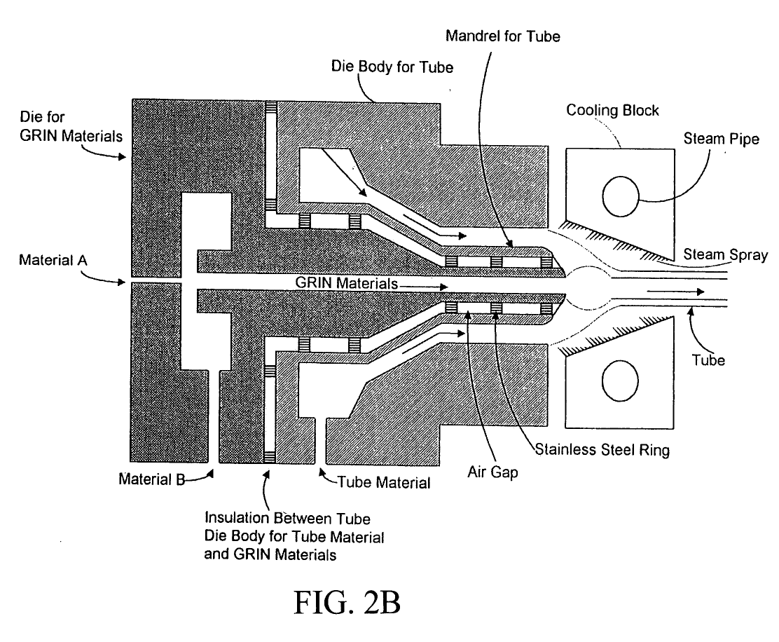

In a specific embodiment, after preparation and blending with the chosen additives, the polymer melts can be transported to an extrusion die, as shown schematically in FIG. 2a. The pressure may be generated by a nitrogen gas pressure source, pump, extruder, piston, or other means known in the art. Two transparent melt polymers, one or both having a transparent and diffusible additive, can enter the die 1 shown schematically in FIG. 2b. Material B forms a concentric shell around material A. The materials A and B are fed at relative rates into die 1 to achieve the desired index profile. Material A can be the same as Material B or it can be different. Although some diffusion can occur as the materials A and B, with any additives they may have, flow through the die 1, such diffusion is not relied on to finalize the index profile. Instead, the die 1 can be designed to minimize the time materials A and B spend in the melt condition at a temperature suitable for extrusion, in order to minimize the optical degradation which can occur when materials A and B are in the melt condition. Such optical degradation can occur due to such high temperatures and due to contact with metal surfaces at such high temperatures. Such optical degradation can occur over periods of time, for example as small as 10-30 seconds, which is often much less than the period of time needed for adequate diffusion, for example as large as 100-1000 seconds. For periods of time over 60 seconds in the melt state suitable for extrusion optical degradation is very likely to occur. In order to provide adequate time for diffusion, the subject invention involves applying an outer tubing and heating the GI-POF to a temperature above its glass transition temperature but much below the extrusion temperature. During this time the outer tubing maintains the structural integrity of the GI-POF. In this way, diffusion of the index-modifying additives can be accomplished without subjecting the polymeric tube materials to the melt state suitable for extrusion for more than about 60 seconds, preferably not more than about 30 seconds, and more preferably not more than about 10 seconds.

If it is desired to incorporate an outer tubing around the polymeric tube at the exit of the die 1, an optional extruder 4 can feed material, for example TEFLON®, to the co-extrusion die to produce an outer tubing within which the aforementioned polymeric tube of materials A and B is contained. Preferably, the material transported by extruder 4 has a glass transition or melt temperature significantly above the glass transition temperatures of materials A and B, and also above the temperature at which it is planned to have the additives diffusing in materials A and B. In a specific embodiment, a thermally processable polymeric material with melt temperature above about 200° C. can be used as an outer tubing. Depending upon the extrusion rate and the choice of outer tubing material, it may be necessary to effect substantial external cooling to the tube as indicated in FIG. 2B.

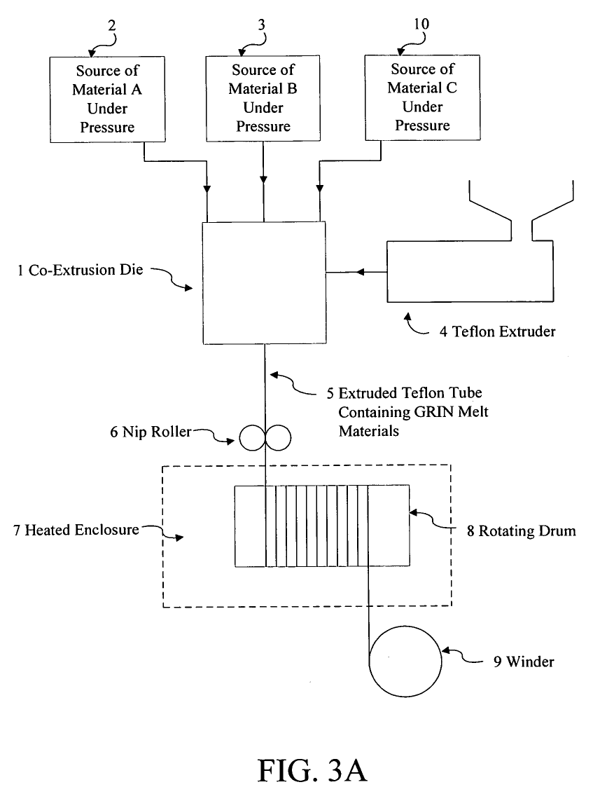

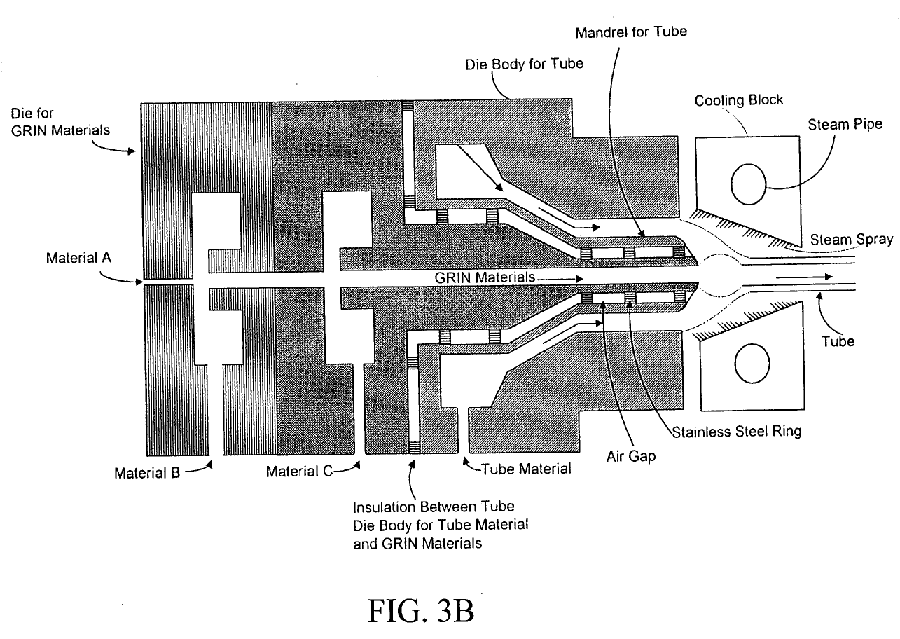

FIG. 3B is a schematic of a die for the case of using three melt blended materials. The method of operation of the die is the same as that in FIG. 2b except for the addition of material C which forms a concentric shell around material B as indicated in FIG. 3b. The subject invention also pertains to four or more melts. In addition, although FIGS. 2b and 3b show two die structures, other die structures can be utilized in accordance with the subject invention to produce multiple concentric cylinders of polymeric materials.

In a specific embodiment, jacketing may be performed after the GRIN POF having an outer tubing exits from the heated enclosure 7 before being finally wound on a winder 9 as shown in FIG. 3A.

In a different embodiment of the subject invention, the outer tubing extruder 4 in FIG. 3a can instead produce a jacket, rather than a thin-walled outer tubing, with say a 2.2 mm diameter.

The jacketed GRIN POF may be passed through the heated enclosure before being wound by the winder, 9, in FIG. 3A.

In a further embodiment of the subject invention, duplex (two parallel, slightly separated optical fibers) GRIN POF may be produced with a jacket as shown in FIG. 4A. In this case, two GRIN POF may be produced and have an outer tubing applied and passed through the heating enclosure as described earlier. The two GRIN POF may then be drawn through a cross-wire die to be jacketed.

Alternatively, the dies shown in FIGS. 2b or 3b may be modified by methods well known in the art of multifiber extrusion to simultaneously extrude two separate streams of polymeric tube material, each of which is composed of concentric cylinders of melt. The outer tubing die may be used to extrude a jacket for the duplex GRIN POF as discussed earlier for the single, or simplex, GRIN POF. A cross-section of the duplex fiber produced in this way is shown in FIG. 4B.

In another embodiment of the invention, a number, n, where n>2, GRIN POF fibers may be extruded simultaneously to form a variety of arrangements of fibers. The arrangements of fibers may be jacketed by the methods described above. Such arrangements may be useful in the very large bandwidth transmission of data through the multiplicity of fibers.

### EXAMPLE 2

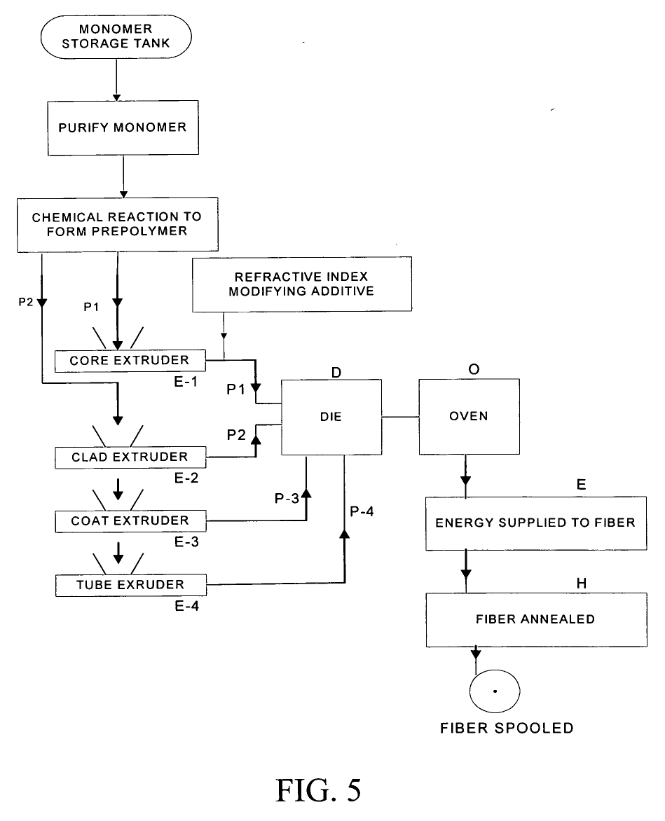

According to one embodiment of the invention, as shown in FIG. 5, purified monomer is reacted to form a prepolymer gel. The prepolymer is fed into a core extruder or gear pump E1 and a clad extruder or gear pump E2. Low molecular weight components of the gel such as monomers and oligomers may be vented from the extruder or gear pump, if desired. One or other, or both, of the prepolymer streams P1 and P2 may be mixed with diffusible dopants or additives. The additive(s) can have a refractive indice(s) which when diffusion is complete provides the desired index profile.

The subject invention teaches a method of minimizing thermal degradation of the prepolymer matrix during the processing of the material within extruders. Thus, processing the prepolymeric material can be performed at low temperature. In a specific embodiment, processing the prepolymeric material is performed for as short a time as possible at the given temperature. As a result, substantially fewer fluorine containing low molecular weight compounds are produced as a result of thermal degradation of the prepolymer. The presence of these low molecular weight compounds, such as hydrofluoric acid, in the prepolymer could result in the presence of radicals, metal ions and metal complexes from the extruder and other light absorbing moieties.

The cited patent literature on the manufacture of acrylic optical fiber teaches that the presence of transition metal ions must be at levels <10⁻⁸ wt/wt of polymer to permit light transmission of 120 dB/km. Since perfluorinated fiber offers an improvement of about thirty to one hundred times less light attenuation than acrylic fiber, the desired upper level of metal ion content can be <10⁻¹⁰ wt/wt.

The subject invention relates to a method which can provide a wide range of control over the temperature of processing the prepolymer. As a result of this control, the level of metal ion concentration and thermal degradation products can be controlled.

To permit processing at low temperature, a specific embodiment of the subject invention can utilize materials such that the molecular weight of the prepolymer matrix can be in the range of about 3,000 to about 30,000 during the extruder processing stage of fiber manufacture. A post-extrusion step can be incorporated to increase the molecular weight of the matrix to a value in the range of about 30,000 to at least about 300,000, which can confer good mechanical and thermal stability to the fiber. There are several ways in which these two manufacturing steps can be implemented in accordance with the subject invention.

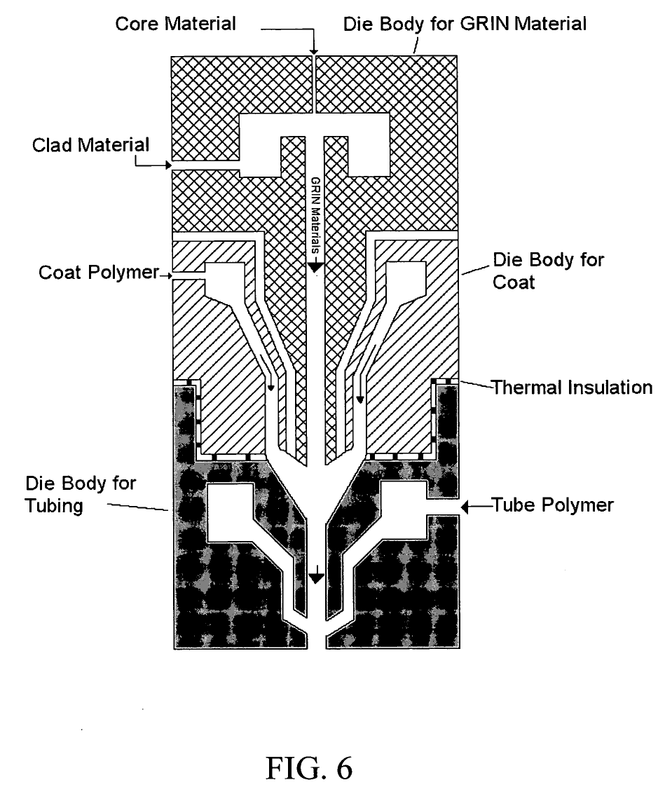

The prepolymer molecular weight can be chosen such that the viscosity of the specific prepolymer plus index modifying material is in the range of about 100 to about 1,000,000 poise and more typically in the range of about 1,000 to about 100,000 poise at extruder E1, E2 which operate with zone temperatures not exceeding about 225° C., more preferably less than 175° C. and even more preferably less than 150° C. It should be noted that these prepolymer process temperatures are typically at least 100° C. less than the processing temperatures of preforms or standard polymer extrusion temperatures. Specifically, the prepolymer weight can be chosen to obtain a desired process temperature. Core and cladding prepolymer materials containing appropriate refractive index modifying additives can be extruded through concentric nozzles in the die D. A cross-sectional view of a specific embodiment of a co-extrusion die in accordance with the subject invention is shown in FIG. 6. The additives may be added to the prepolymer gel prior to, during, or after the extrusion process.

A third extruder E3 can provide a concentric coat polymer, P3, of low refractive index on the outside of the core-clad structure. The thickness of the coat polymer is not limited, but is preferentially in the range of about 2 to about 500 microns and more preferably in the range of about 5 to about 50 microns. This coat polymer can reduce, or minimize, light losses when the fiber is bent with a small bend radius. The refractive index of the coat polymer is preferably lower by at least 0.005 compared to the outer surface of the clad polymer. The difference in the refractive index is more preferably greater than 0.015, and most preferably more than 0.03. In general, the smaller the fiber diameter the smaller the loss of light for a given bend angle. The diameter of the light transmission region (core plus clad) of the subject fiber is not limited but is preferably less than 1000-microns and more preferably less than 200 microns. The coat polymer preferably contains a low refractive index additive.

Finally, a fourth polymer P4 can be extruded from extruder E4 and form a solid tube to surround the three inner polymeric materials. This tube can provide structural support throughout the thermal processing of the inner polymeric materials. The thickness of the tubing polymer is not limited, but is preferably in the range of about 20 to about 500 microns and more preferably in the range of about 40 to about 200 microns. The polymeric material forming this tube can be chosen so as to retain its structural mechanical properties up to a temperature of at least 175° C. and preferably up to a temperature of at least 200° C. The polymeric material forming the tube can be extruded through a section of the die shown in FIG. 6 that is preferably but not necessarily, thermally insulated from the rest of the die. This thermal insulation may be desirable because of the potential temperature difference between the two sections of the die. The temperature of the die body for forming the tubing can be in the range of about 175° C. to about 280° C., which can be substantially above the temperature range of the rest of the die, which can be in the range of, for example, about 100° C. to about 175° C.

The four-component fiber can enter a heated oven O where the temperature can be in the range of about 125 degree Celsius to about 200 degree Celsius. The additives can diffuse rapidly in the prepolymers to produce the desired graded index profile. Within the oven, the fiber can be wound on a rotating drum structure. The diameter and length of the rotating drum can be selected such as to maintain the fiber in the oven for a time period adequate to produce the desired index profile. Design parameters of this process step have been described in U.S. Published Application No. 20020041042, which is incorporated herein by reference in its entirety.

The fiber can then be exposed to a source of energy E to activate the prepolymer and thereby increase the polymer molecular weights to the range of about 30,000 to about 300,000 and their glass transition temperatures to greater than 105 degrees Celsius and preferably greater than 120 degrees Celsius. The source of energy may be electromagnetic radiation, including ultraviolet, visible, or infrared radiation; ionizing radiation, including x-rays, electron beam, or other particulate energy; ultrasound; and/or thermal energy.

In a specific embodiment of the subject invention, the source of energy, E, can be located within the oven. In a specific embodiment, the oven can supply thermal energy as the source of energy, E.

In a further embodiment of the invention, the source of energy, E, is located between the exit of the die and the entrance to the oven. In this case, all diffusion of the additive(s) occurs in the final polymeric matrix. This embodiment leads to slower development of the final index profile, but in some cases can provide a higher degree of control of the profile.

In another specific embodiment, the additive diffusion can be accomplished in two, or more, stages. For example, a portion of the additive diffusion can be accomplished before supplying energy to activate the prepolymer and the remaining additive diffusion can be accomplished after activation of the prepolymer. In this example, the additive diffusion prior to activation of the prepolymer can be fast, while the additive diffusion after the activation of the prepolymer can allow ore accurate control of the final diffusion result. The subject invention relates to a method where the fiber can be thermally annealed to minimize residual stress. The continuously extruded fiber can be coiled in a helical form on a roller within a heated enclosure H. A temperature gradient can exist along the axis of the roller and heated enclosure. The time dependence of the drop in temperature of the fiber can be controlled by the spatial dependence of the above temperature gradient. The radial temperature difference between the axis and outer radius of the fiber can be minimized as the fiber temperature falls and the polymer matrix of the fiber enters the glassy state and continues to cool to ambient temperature. This temperature difference is preferably always less than 6° C. and most preferably less than 3° C. In this way, residual radial and longitudinal stress in the fiber can be minimized prior to spooling the fiber.

In another embodiment of the subject invention, the die D in FIG. 5 can employ multiple concentric structures of the type shown in FIG. 6. Multiple single POF can be simultaneously produced and each processed as described schematically in FIG. 5. This embodiment can provide several thousand meters of Simplex cable per minute.

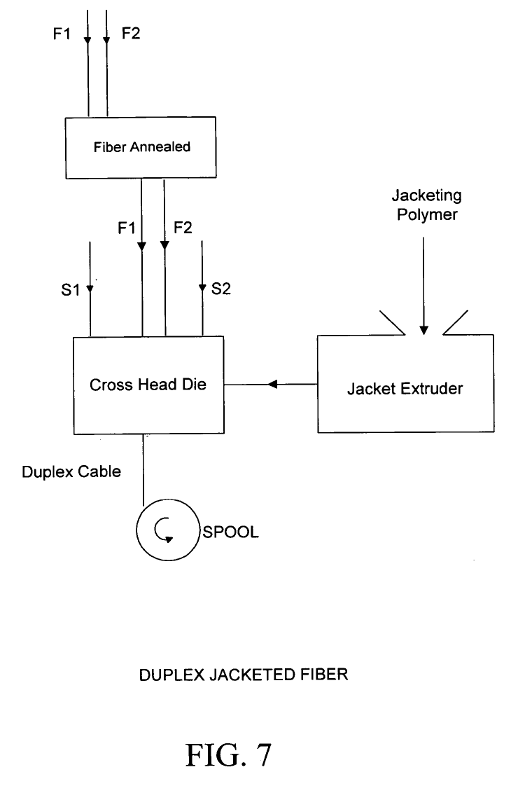

Another embodiment of the subject invention relates to the production of duplex cable as shown in FIG. 7. In this embodiment, the die shown in FIG. 6 can be modified to permit the simultaneous production of two plastic optical fibers each identical to an embodiment of the subject single fiber described heretofore.

### EXAMPLE 3

In a specific embodiment of the subject invention, two or more concentric cylinders of transparent polymer melts, of which at least one is a cross-linkable material, can be utilized to produce a plastic optical transmission medium. In addition, zero, one, or more transparent, non-reactive, low molecular weight diffusible additive(s) can be added to zero, one, or more of the transparent polymer melts to provide a graded refractive index profile. The molecular weights and chemical structures of the index modifying additives can be chosen to ensure their diffusion constants are low enough to provide a stable refractive index profile at the desired operating temperature of the fiber. Preferred additives are: diphenyl sulphide and methyl perfluoro octanate. These additives are discussed in U.S. patent application Ser. Nos. 10/804,982 and 10/775,567, which are hereby incorporated by reference in their entirety. Many other suitable additives that are well known in the art of manufacture of graded-index plastic optical fiber can be utilized in accordance with the subject invention. The cylinders of melt can be extruded into a solidified polymeric tube via, for example, a cross-head type of die. The tube containing the melt materials can be maintained at high temperature for a specific time period, such that the cross-linking can occur and, optionally, the additives can diffuse within the polymeric tube.

The chemical composition of the polymers can be selected to meet the desired optical, thermal, relative humidity and mechanical properties of the resulting optical transmission medium.

The subject invention can utilize organic polymers, partially fluorinated and/or perfluorinated polymers to manufacture step/graded-index POF with one or more of the desired properties.

A preferred choice of organic polymer suitable for the above type of fiber is in the methacrylate family. Other amorphous organic polymers may be used such as polystyrene, polycarbonate and copolymers thereof. These polymers and others are addressed in U.S. patent application Ser. No. 10/804,982.

Suitable cross-linkable core polymer mixtures may incorporate any amorphous organic, partially fluorinated or perfluorinated polymer. Such polymers include polycyclohexyl methacrylate, polyphenyl methacrylate, polytrifluoroethyl methacrylate, poly (2,2,3,3- tetrafluoropropyl-α-fluoroacrylate), polystyrene and its derivatives, polycarbonate and its derivatives. Examples of suitable perfluorinated amorphous polymers are 2,2-bistrifluoromethyl-4,5-difluoro-1,3-dioxole (PDD) homopolymer and its derivatives, perfluorocyclobutyl (PFCB) polaryl ethers and derivatives and other perfluorinated polymers discussed in U.S. patent application Ser. No. 10/775,567.

Suitable cladding polymers include, for example, thermoplastic, cross-linkable polymer mixtures, and/or semi-crystalline polymers. Examples of thermoplastic cladding materials are polymers of methacrylate derivatives with at least one hydrogen atom being substituted with a fluorine atom, polymers of styrene derivatives with at least one hydrogen atom being substituted with a fluorine atom, copolymers of these methacrylate and styrene derivatives, fluorine substituted polycarbonate. Examples of semi-crystalline polymers are polyvinylidene fluoride, vinylidene fluoride-tetrafluoroethylene copolymers, vinylidene fluoride-hexafluoropropylene copolymers, vinylidene fluoride-tetrafluoroethylene-hexafluoropropylene terpolymers, silicone resins and ethylene-vinyl acetate copolymers.

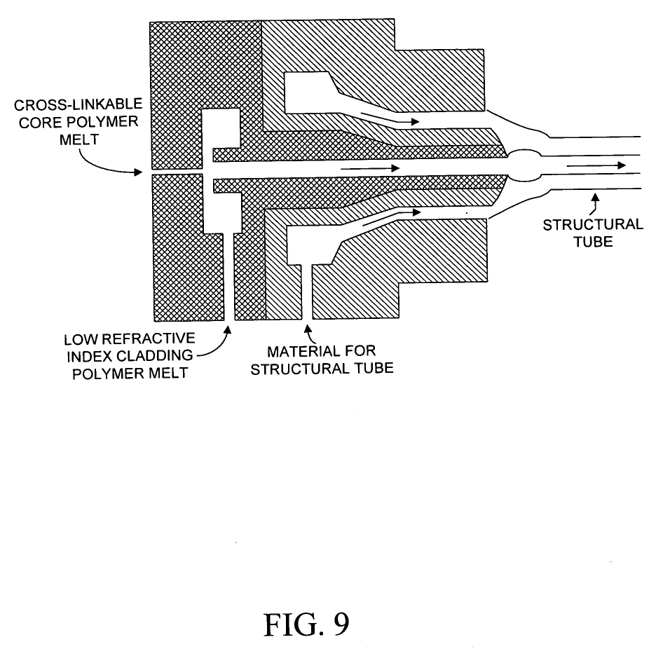

The core and cladding polymer cylinders can be extruded within the extruded structural tubing, for example, as indicated by the die shown in FIG. 9. Optional structural polymeric tubing materials are discussed in U.S. patent application Ser. No. 10/775,567. In the subject invention, the tubing is preferably be held at a temperature in the range of about 130° C. to 170° C. to complete the cross-linking. A suitable structural polymer material for the subject invention is polyethylene terephalate (PET).

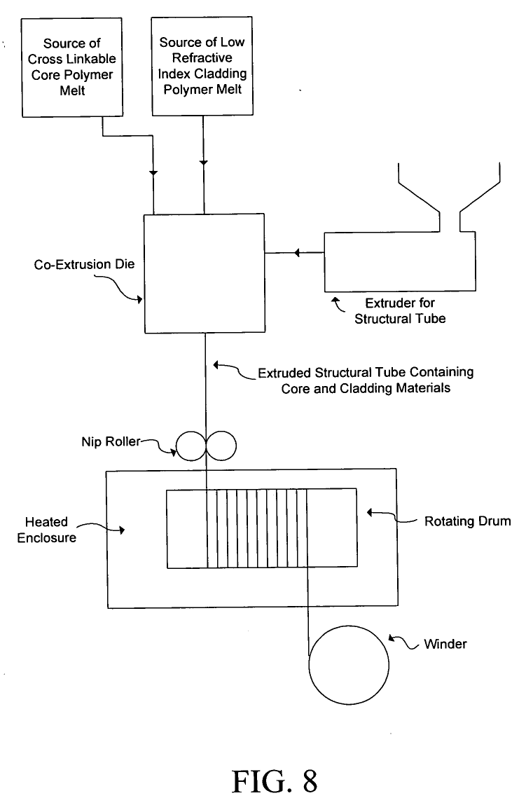

In a specific embodiment, the POF fiber can be wound continuously on a rotating heated drum as shown in FIG. 8. The number of POF turns on the drum can be controlled to give the desired time period for cross-linking to occur in the temperature range of, for example, 130° C. to 170° C. The cross linking can be effected by heat, ultraviolet radiation, any form of radiation energy, or combinations thereof.

It is to be understood that various configurations of the multiplicity of fibers which include but are not limited to single fibers, duplex fibers, ribbons, stacks of ribbons and bundles of fibers may be used to produce multifiber cable. The production may be continuous or it may be allowed to contain one or more steps in the process as described above.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method of manufacturing a plurality of polymer optical fibers, comprising:
preparing one or more polymeric materials; and
extruding the one or more polymer materials to simultaneously produce a plurality of polymer optical fibers,
wherein the method is continuous.

2. The method according to claim 1,
wherein preparing one or more polymeric materials comprises synthesizing a corresponding one or more prepolymeric materials and effecting the polymerization of the one or more prepolymeric materials so as to produce one or more polymer materials.

3. The method according to claim 1, further comprising:
simultaneously producing a plurality of polymer optical fiber cables, wherein each polymer optical fiber cable incorporates at least one of the plurality of polymer optical fibers.

4. The method according to claim 1, further comprising:
producing a multi-polymer optical fiber cable from the plurality of polymer optical fibers.

5. The method according to claim 2,
wherein preparing one or more polymeric materials comprising preparing one or more polymeric materials with a molecular weight in the range of about 5000 Daltons to about 50,000 Daltons.

6. The method according to claim 5, further comprising:
effecting further polymerization of the one or more polymer materials in each of the plurality of polymer optical fibers.

7. The method according to claim 1,
wherein preparing one or more polymeric materials comprises preparing one or more polymeric materials with a molecular weight in the range of about 40,000 Daltons to about 100,000 Daltons.

8. The method according to claim 2, wherein effecting the polymerization of the one or more prepolymeric materials comprises adding additives to the one or more prepolymeric materials that effects the polymerization of the one or more prepolymer materials.

9. The method according to claim 8, wherein the additives added to the one or more prepolymeric materials enhance cross-linking of at least one of the one or more prepolymeric material.

10. The method according to claim 8, wherein the additives added to the one or more prepolymeric materials enhance extensioning of at least one of the one or more prepolymeric materials.

11. The method according to claim 1, wherein extruding the one or more polymer materials comprises extruding the one or more polymer materials from a multi-hole spinneret.

12. The method according to claim 11, wherein extruding the one or more polymer materials from a multi-hole spinneret comprises extruding the one or more polymer materials through the multi-hole spinneret via micro-gear pumps.

13. The method according to claim 1, further comprising adding refractive index modifying additives to the one or more polymer materials prior to extruding the one or more polymer materials.

14. The method according to claim 13, wherein the plurality of polymer optical fibers have high stability up to temperatures of at least about 85° C.

15. The method according to claim 13, wherein the plurality of polymer optical fibers have high stability up to temperatures of at least about 125° C.

16. The method according to claim 1, wherein the one or more polymer materials comprise polymer material selected from the group consisting of: organic polymer material, partially fluorinated polymer material, fluorinated polymer material, perfluorinated polymer material, fluoro plus chlorinated polymer material, halogenated carbon polymer material, and silicon based polymer material.

17. The method according to claim 1, wherein the one or more polymer materials comprises organic polymer material.

18. The method according to claim 1, wherein the one or more polymer materials comprises partially fluorinated polymer material.

19. The method according to claim 1, wherein the one or more polymer materials comprises fluorinated polymer material.

20. The method according to claim 1, further comprising drawing each of the plurality of polymer optical fibers to provide a desired molecular alignment.

21. The method according to claim 1, further comprising jacketing each of the plurality of polymer optical fibers to produce a corresponding plurality of Simplex cables.

22. The method according to claim 4, wherein producing a multi-polymer optical fiber cable comprises spooling at least one of the plurality of polymer optical fibers and producing a multi-polymer optical fiber cable incorporating the at least one of the plurality of polymer optical fibers from the spool.

23. The method according to claim 4, wherein producing a multi-polymer optical fiber cable comprises jacketing together at least two of the plurality of polymer fibers to produce a multi-polymer optical fiber cable.

24. The method according to claim 24, wherein producing a multi-polymer optical fiber cable comprises producing at least one Duplex cable.

25. The method according to claim 24, wherein producing each of the at least one Duplex cable comprises:
passing a pair of polymer optical fibers from the plurality of polymer optical fibers through a crosshead die,
coating the pairs of polymer optical fibers with a curable polymer, and
curing the curable polymer.

26. The method according to claim 25, wherein the curable polymer is an ultraviolet curable polymer.

27. The method according to claim 24, wherein eight Duplex cables are produced with sixteen polymer optical fibers from the plurality of polymer optical fibers, wherein each Duplex cable incorporates two polymer optical fibers from the plurality of polymer optical fibers.

28. The method according to claim 1, further comprising:
producing at least one ribbon of polymer optical fibers, wherein each of the at least one ribbon of polymer optical fibers incorporates at least two polymer optical fibers from the plurality of polymer optical fibers.

29. The method according to claim 28, wherein producing each of the at least one ribbon of polymer optical fibers comprises:
passing at least two of the plurality of polymer optical fibers through a crosshead die,
coating the at least two of the plurality of polymer optical fibers with a curable polymer, and
curing the curable polymer to produce a ribbon of polymer optical fibers incorporating the at least two of the plurality of polymer optical fibers.

30. The method according to claim 29, wherein the curable polymer is an ultraviolet curable polymer.

31. The method according to claim 29, wherein two ribbons of polymer optical fibers each incorporating eight polymer optical fibers of the plurality of polymer optical fibers are produced from sixteen polymer optical fibers of the plurality of polymer optical fibers, wherein the crosshead die is an eight-hole crosshead die.

32. The method according to claim 29, further comprising jacketing at least two ribbons of polymer optical fibers together so as to produce a corresponding at least two layers of polymer optical fiber ribbon jacketed together.

33. The method according to claim 1, wherein each of the plurality of polymer optical fiber comprises an outer tube.

34. The method according to claim 4, wherein the multi-polymer optical fiber cable comprises an outer tube jacketing at least two of the plurality of polymer optical fibers.

35. The method according to claim 4, wherein the multi-polymer optical fiber cable comprises a strength component.

36. The method according to claim 4, wherein the multi-polymer optical fiber cable is designed such that portions of the cable can be stripped away from the remainder of the cable, wherein the portion of the cable incorporates at least one of the polymer optical fibers and the remainder of the cable incorporates at least one of the other polymer optical fibers.
